(19) United States
(12) Patent Application Publication
(10) Pub. No.: US 2026/0189129 A1
(43) Pub. Date: Jul. 2, 2026

(54) HYBRID SINGLE MODE BUCK BOOST CONVERTER

(71) Applicant: KOREA UNIVERSITY RESEARCH AND BUSINESS FOUNDATION, Seoul (KR)

(72) Inventors: Hyung-Min LEE, Seoul (KR); Hyun-Jun PARK, Seoul (KR)

(21) Appl. No.: 19/321,012

(22) Filed: Sep. 5, 2025

(30) Foreign Application Priority Data
Jan. 2, 2025 (KR) 10-2025-0000141

(51) Int. Cl. H02M 1/00; H02M 1/14; H02M 3/00; H02M 3/137; H02M 3/158

(52) U.S. Cl. CPC H02M 1/0095; H02M 1/143; H02M 3/003; H02M 3/137; H02M 3/1582

(57) ABSTRACT

A hybrid single-mode buck-boost converter is disclosed. The hybrid single-mode buck-boost converter comprises: an inductor having a first terminal connected to the input voltage (V_{IN}) and a second terminal connected to an intermediate node (Vx); a switched-capacitor network circuit connected to the inductor through the intermediate node (Vx) and configured to perform switching operations to maintain a voltage at the intermediate node at a specified ratio of the output voltage of the buck-boost converter; and an output capacitor connected to the switched-capacitor network circuit through an output node.

### CROSS-REFERENCE TO RELATED APPLICATION

This application claims the benefit of priority under 35 U.S.C. § 119(a) to Korean Patent Application No. 10-2025-0000141 filed on Jan. 2, 2025, the entire contents of which is incorporated herein by reference.

### BACKGROUND

### (a) Technical Field

The present disclosure relates to a hybrid single-mode buck-boost converter that achieves high power efficiency and high current density by reducing inductor current ripple.

### (b) Background Art

As shown in FIG. 1, a lithium-ion battery used in a mobile device discharges over time from 4.2 V to 2.9 V. However, functional blocks such as Bluetooth, eMMC, SD card, Wi-Fi, and a camera require a constant supply voltage of 3.4 V. Accordingly, a buck-boost DC-DC converter capable of both step-down and step-up operation is essential in mobile devices. Given the nature of mobile devices, a breakthrough is needed for this converter to achieve both high power efficiency and high power density. However, these objectives are in conflict due to the large parasitic resistance (DCR) of the inductor when a small inductor is used.

In conventional buck-boost converter architectures, because current is delivered to the output discontinuously, the average inductor current (IL) is high; therefore, when a small-footprint inductor having a high DCR is used for compact systems, efficiency degrades further. In addition, the large voltage swing across the inductor produces a large inductor current ripple (ΔIL), which necessitates an inductor of higher inductance and larger size.

To overcome these inductor-related limitations, various hybrid topologies employing flying capacitors (CF) have been proposed. Multiple-mode buck-boost converters reduce the inductor current ripple (ΔIL) by employing conversion-ratio-dependent (M=VOUT/VIN) segmented mode operation.

However, during the discontinuous mode transition between M<1 and M>1, this converter experiences severe excursions in the output voltage (VOUT). Accordingly, precise voltage sensing and mode control are required to achieve smooth mode transition, which increases system complexity and makes the system vulnerable to various disturbances and variations. To address this issue, single-mode buck-boost converters have been proposed, which reduce the inductor current ripple (ΔIL) to improve efficiency even when a small inductor with large DCR is used. However, conventional single-mode buck-boost converters have employed LDMOS transistors—having inferior on-resistance (RDS(on)) characteristics—in order to withstand the high voltages across the switches. In addition, the large swing in the inductor voltage (VL) makes conventional single-mode buck-boost converters inefficient at reducing ΔIL.

### SUMMARY OF THE DISCLOSURE

The present disclosure aims to provide a hybrid single-mode buck-boost converter that simultaneously achieves high power efficiency and current density by reducing inductor current ripple.

Further, the present disclosure provides a hybrid single-mode buck-boost converter configured to operate in buck and boost modes by controlling a duty D.

In addition, the present disclosure provides a hybrid single-mode buck-boost converter in which the inductor is directly connected to a current source and current is continuously delivered to the load through a dual-path switched-capacitor network.

According to one aspect of the present disclosure, a hybrid single-mode buck-boost converter is provided.

According to one embodiment of the present disclosure, there may be provided a hybrid single mode buck boost converter comprising: an inductor having one end connected to an input voltage(V_{IN}) and another end connected to an intermediate node (Vx); a switched-capacitor network circuit coupled to the inductor through the intermediate node (Vx) and configured to perform switching operations to maintain a voltage at the intermediate node at a specific ratio of an output voltage of the buck-boost converter; and an output capacitor connected to the switched-capacitor network circuit through an output node.

The switched-capacitor network circuit may include: a first switch (S₁) having a first terminal connected to the inductor through the intermediate node (Vx) and a second terminal connected to a first contact node (V_{T1}); a second switch (S₂) having a first terminal connected to the first switch (S₁) through the first contact node (V_{T1}); a third switch (S₃) arranged in parallel with the first switch (S₁), having a first terminal connected to the inductor through the intermediate node (Vx) and a second terminal connected to a second contact node (V_{B1}); a fourth switch (S₄) having a first terminal connected to the first switch (S₃) through the second contact node (V_{B1}) and an output terminal connected to an output terminal of the second switch (S₂); a first flying capacitor (C_{F1}) having a first terminal connected to the first contact node (V_{T1}) and a second terminal connected to the second contact node (V_{B1}); a fifth switch (S₅) having a first terminal connected to the intermediate node (Vx) through a third contact node (V_{T2}); a second flying capacitor (C_{F2}) having a first terminal connected to the third contact node (V_{T2}); a sixth switch (S₆) having a first terminal connected to the second flying capacitor (C_{F2}) through a fourth contact node (V_{B2}) and a second terminal connected to the fifth switch (S₅); a seventh switch (S₇) having a first terminal connected to the second flying capacitor (C_{F2}) through the fourth contact node (V_{B2}) and a second terminal connected to ground; and a third flying capacitor (C_{F3}) having a first terminal connected to the fifth switch (S₅) and the sixth switch (S₆) through a fifth contact node (V_{T3}), and a second terminal connected to ground.

The first switch(S₁) and the second switch(S₂) are cross-coupled, and the third switch(S₃) and the fourth switch(S₄) are cross-coupled.

Additionally, the first switch(S₁) and the second switch(S₂) are each of the same transistor type selected from PMOS and NMOS, and the third switch (S₃) and the fourth switch (S₄) are each of the other transistor type.

The switched-capacitor network circuit is configured that, during a first phase in which the inductor is charged, the fifth switch(S₅) and the seventh switch (S₇) are turned ON to connect the second flying capacitor (C_{F2}) and the third flying capacitor (C_{F3}) in parallel so that current is delivered from ground to the intermediate node (Vx), and the second switch (S₂) and the third switch (S₃) are turned ON to connect the first flying capacitor (C_{F1}) and the output capacitor in series. During a second phase, the first switch (S₁) and the fourth switch (S₄) are turned ON to connect the first flying capacitor (C_{F1}) and the output capacitor in series, and the sixth switch (S₆) is turned ON to connect the second flying capacitor (C_{F2}) and the third flying capacitor (C_{F3}) in series, whereby the inductor freewheels.

### BRIEF DESCRIPTION OF DRAWINGS

FIG. 1 is a diagram illustrating the prior art.

FIG. 2 is a circuit diagram of a hybrid single-mode buck-boost converter according to one embodiment of the present disclosure.

FIG. 3 illustrates comparative waveforms of the inductor terminal voltage and the inductor current ripple for a hybrid single-mode buck-boost converter according to one embodiment of the present disclosure.

FIG. 4 is a phase concept diagram of a hybrid single-mode buck-boost converter according to one embodiment of the present disclosure.

FIG. 5 is a diagram comparing volume and DCR versus inductance according to one embodiment of the present disclosure.

FIG. 6 is a detailed circuit diagram of a hybrid single-mode buck-boost converter according to one embodiment of the present disclosure.

FIGS. 7 and 8 are diagrams illustrating, as a function of duty (D), the operation of a hybrid single-mode buck-boost converter according to one embodiment of the present disclosure.

FIG. 9 is a diagram comparing the rectified inductor current ripple I_{L} and the maximum switch voltage between the prior art and a hybrid single-mode buck-boost converter according to one embodiment of the present disclosure.

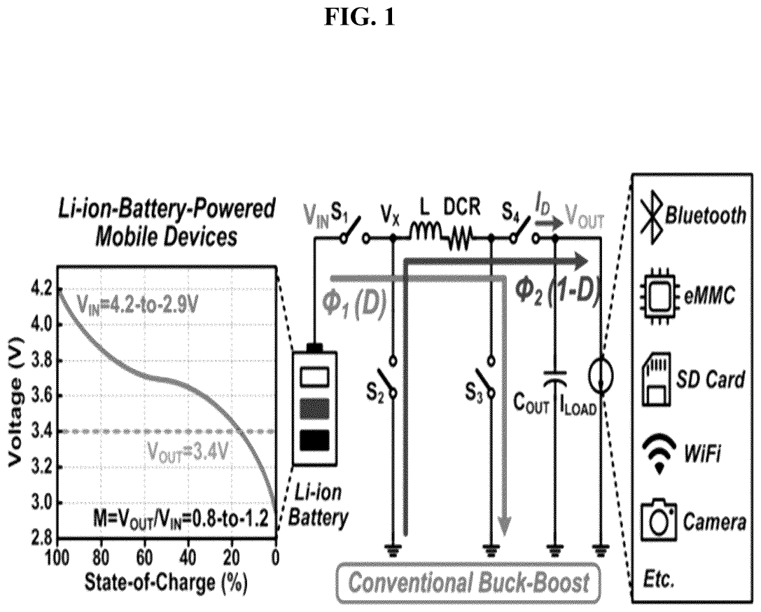

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “˜unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

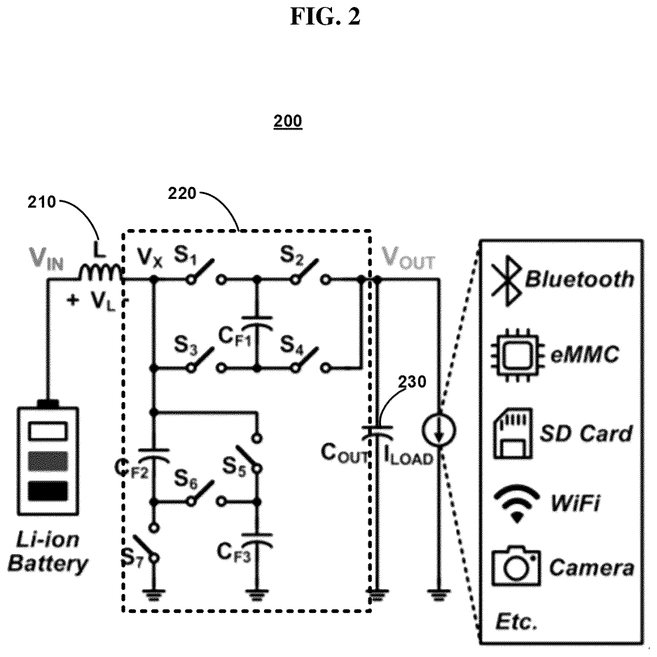

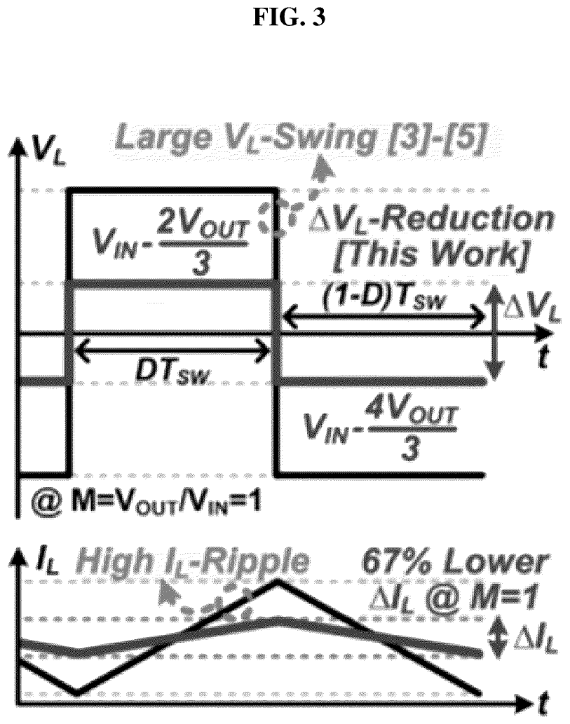

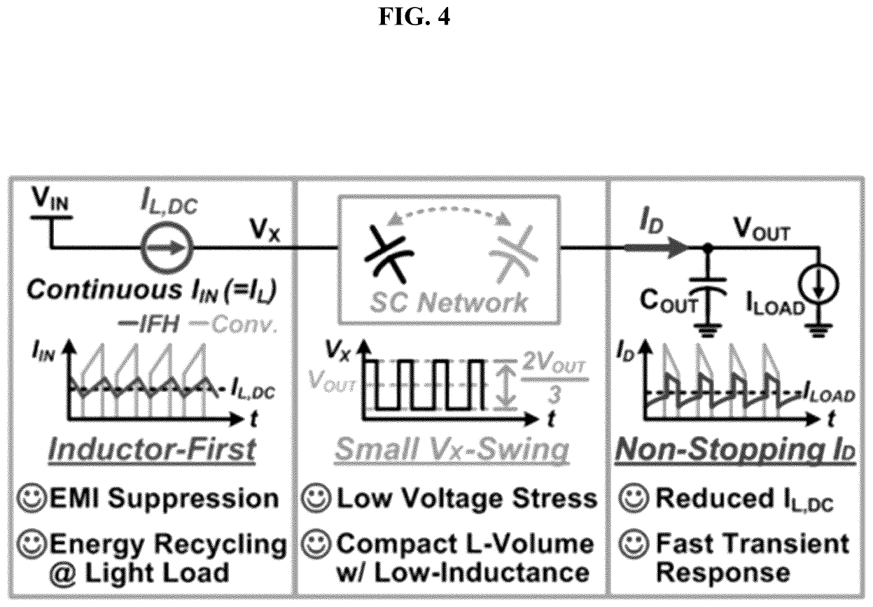

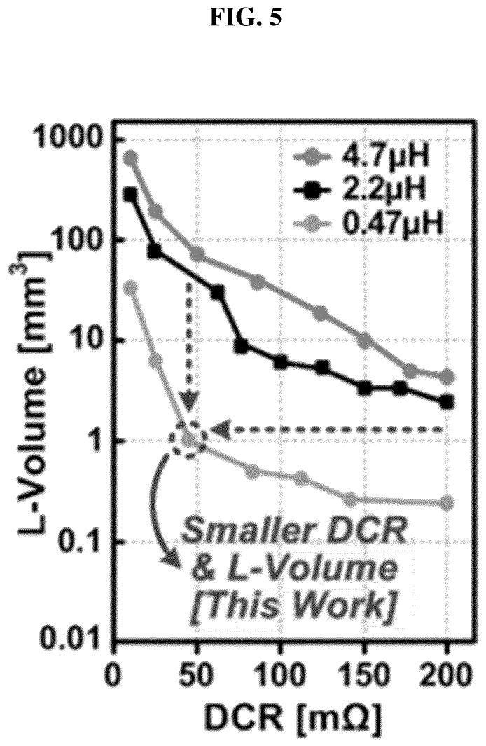

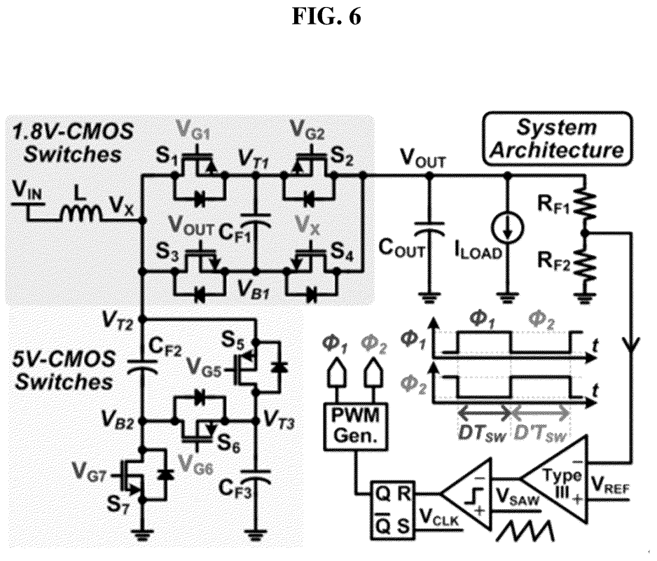

FIG. 2 is a circuit diagram of a hybrid single-mode buck-boost converter according to one embodiment of the present disclosure, FIG. 3 illustrates comparative waveforms of the inductor terminal voltage and the inductor current ripple for a hybrid single-mode buck-boost converter according to one embodiment of the present disclosure, FIG. 4 is a phase concept diagram of a hybrid single-mode buck-boost converter according to one embodiment of the present disclosure, FIG. 5 is a diagram comparing volume and DCR versus inductance according to one embodiment of the present disclosure, and FIG. 6 is a detailed circuit diagram of a hybrid single-mode buck-boost converter according to one embodiment of the present disclosure.

As illustrated in FIG. 3, the hybrid single-mode buck-boost converter 200 according to one embodiment of the present disclosure maintains single-mode operation while, at the same time, reducing the swing of the inductor voltage ΔV L so as to minimize the inductor current ripple ΔI_{L}. Accordingly, the architecture of the hybrid single-mode buck-boost converter 200 according to one embodiment of the present disclosure reduces ΔV_{L} to 2·V_{OUT}/3 over the entire conversion-ratio range M, thereby achieving a substantial reduction in ΔI_{L}.

Referring to FIGS. 2 and 6, the hybrid single-mode buck-boost converter 200 according to one embodiment of the present disclosure comprises a single inductor 210, a switched-capacitor network circuit 220 and an output capacitor 230.

A first terminal of the inductor 210 is connected to the input voltage V_{IN}, and a second terminal is connected to the switched-capacitor network circuit 220 through the intermediate node (Vx).

Referring to FIG. 4, by directly connecting the inductor 210 to the input voltage V_{IN}, the input current I_{IN} becomes continuous, which can attenuate electromagnetic interference (EMI) noise caused by abrupt current changes. When EMI noise is significant, systems connected to the battery can experience severe voltage fluctuations, accordingly, mitigating such noise is critically important.

In one embodiment of the present disclosure, by directly connecting the inductor 210 to the input voltage V_{IN} in an inductor-first topology, the inductor current (I_{L}) at light load (I_{LOAD}) is returned and stored back into the input voltage V_{IN} for reuse, thereby reducing power loss and minimizing efficiency degradation.

As shown in FIG. 4, the switched-capacitor network circuit 220 has a first terminal connected to the inductor 210 through the intermediate node (Vx), and a second terminal connected to the output capacitor 230. The switched-capacitor network circuit 220 may control seven switches such that the voltage at the intermediate node (Vx) swings within a specified range relative to the output voltage (V_{OUT}) of the output capacitor 230 (e.g., around 2·VOUT/3; see FIG. 5). Accordingly, the ripple current (ΔI_{L}) of the inductor 210 can be reduced. As shown in FIG. 5, the reduction in ΔI_{L} enables the use of an inductor with a low inductance L(=0.47μH), having a relatively small direct-current resistance (DCR) and a small volume. Also, the hybrid single-mode buck-boost converter 200 according to one embodiment of the present disclosure continuously delivers a current (I_{D}) to the load, thereby achieving reduced inductor current ripple (ΔI_{L}) and fast transient response.

The switched-capacitor network circuit 220 may perform switching operation in a first phase and a second phase during one switching period. In the first phase, the flying capacitors are connected in parallel so that the inductor 210 is charged, and in the second phase, the flying capacitors are connected in series so that the inductor 210 is discharged.

This will be described in greater detail below.

The switched-capacitor network circuit 220 includes three flying capacitors (C_{F1} to C_{F3}) and seven switches (S₁ to S₇).

A first terminal of the first switch S₁ is connected to the intermediate node Vx, and a second terminal is connected, through a first contact node V_{T1}, to a first terminal of a second switch S₂.

A first terminal of the third switch S₃ is connected to the intermediate node Vx, and a second terminal is connected, through a second contact node V_{B1}, to a first terminal of the fourth switch S₄.

A first terminal of the first flying capacitor C_{F1} is connected to the first contact node V_{T1}, and a second terminal may be connected to the second contact node V_{B1}.

The first switch S₁ and the second switch S2 are cross-coupled, and the third switch S3 and the fourth switch S4 may be cross-coupled (see FIG. 6).

Also, the first switch S₁ and the second switch S₂ may each be of the same transistor type selected from PMOS and NMOS, and the third switch S₃ and the fourth switch S4 may each be of the other transistor type (see FIG. 6).

Additionally, a first terminal of the fifth switch S₅ is connected to the intermediate node Vx through a third contact node V_{T2}, and a second terminal may be connected, through a fifth contact node V_{T3}, to a first terminal of the third flying capacitor C_{F3}. In addition, a second terminal of the third flying capacitor C_{F3} may be connected to ground.

Additionally, a first terminal of the second flying capacitor C_{F2} is connected to the third contact node V_{T2}, and a second terminal is connected, through a fourth contact node V_{B2}, to a first terminal the seventh switch S₇.

A first terminal of the sixth switch S₆ is connected to the fourth contact node V _{B2}, and a second terminal may be connected to the fifth contact node V_{T3}.

Additionally, a first terminal of the seventh switch S₇ is connected to the second flying capacitor C_{F2} through the fourth contact node V_{B2}, and a second terminal may be connected to ground.

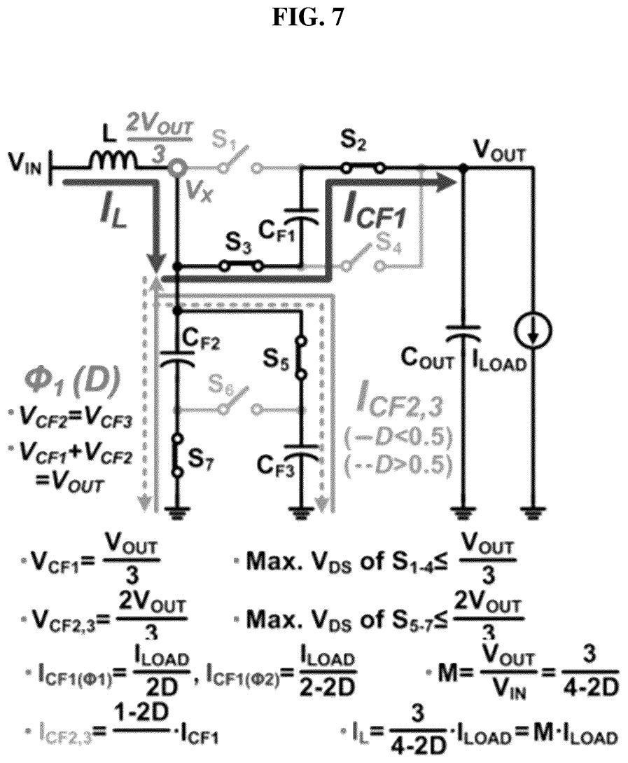

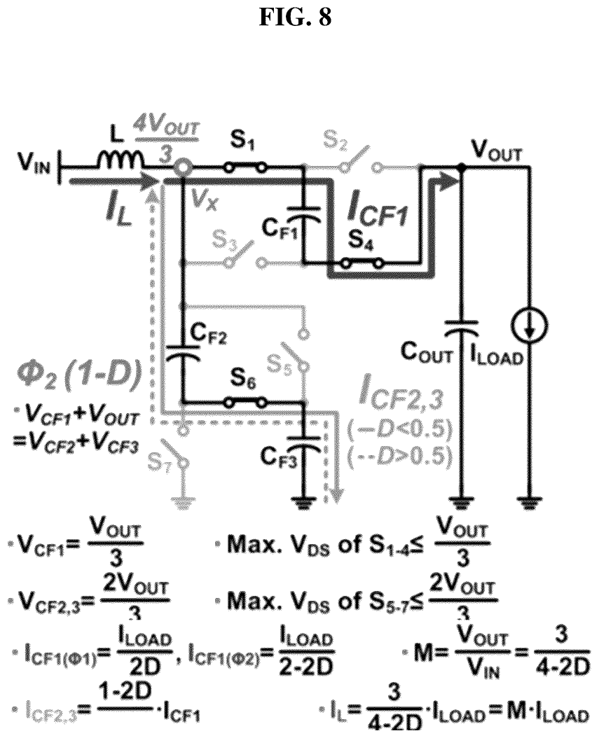

The operation of the hybrid single-mode buck-boost converter will now be described with reference to FIGS. 7 and 8.

In one switching period (T_{SW}), the hybrid single-mode buck-boost converter 200 according to one embodiment of the present disclosure operates in two phases (φ₁, φ₂)

During the first phase φ₁, the inductor 210 is charged with V_{L}=V_{IN}−2·V_{OUT}/3. During the first phase φ₁, the switched-capacitor network circuit 220 is controlled so that the second flying capacitor C_{F2} and the third flying capacitor C_{F3} are connected in parallel.

This will be described in greater detail below.

Referring to FIG. 7, during the first phase φ₁, the second switch S₂, the third switch S₃, the fifth switch S₅, and the seventh switch S₇ are turned ON, and the first switch S₁, the fourth switch S₄, and the sixth switch S₆ are turned OFF.

Accordingly, the second flying capacitor C_{F2} is connected in parallel with the third flying capacitor C_{F3}, and the first flying capacitor C_{F1} is connected in series with the second flying capacitor C_{F2} and the output capacitor C_{OUT}. As a result, the output voltage V_{OUT} of the output capacitor 230 is equal to the sum of the voltage V_{CF1} of the first flying capacitor and the voltage V_{CF2} of the second flying capacitor. As a result, when the duty D is less than 0.5, the currents (I_{CF2}, I_{CF3}) of the second and third flying capacitors (C_{F2}, C_{F3}) flow from ground (GND) to the intermediate node Vx, thereby charging the inductor 210.

Referring to FIG. 8, during the second phase φ₂, the first switch S₁, the fourth switch S₂, and the sixth switch S₂ are turned ON, and the second switch S₂, the third switch S₃, the fifth switch S₅, and the seventh switch S₇ are turned OFF. Accordingly, during the second phase φ₂, the first flying capacitor C_{F1} is connected in series with the output capacitor C_{OUT}, and the second flying capacitor C_{F2} is connected in series with the third flying capacitor C_{F3}. As a result, the inductor 210 has V_{L}=V_{IN}−4V_{OUT}/3, and may freewheel. The currents of the second and the third flying capacitors (C_{F2}, C_{F3}) flow from ground to the intermediate node Vx when the duty is less than 0.5, when the duty is greater than 0.5, the direction of conduction is reversed and currents flow from the intermediate node (Vx) to ground. The current I_{CF1} of the first flying capacitor C_{F1} always delivered to the output (i.e., to the output voltage V_{OUT}) during both the first phase and the second phase for all values of duty (D).

With respect to the voltages across the respective switches of the switched-capacitor network circuit 220, the first through fourth switches (S₁-S₄) and the fifth through seventh switches (S₅-S₇) are subject to reduced voltages of approximately V_{OUT}/3 and 2·V_{OUT}/3, respectively. Accordingly, in one embodiment of the present disclosure, the power stage can be implemented using low-voltage transistors (e.g., 1.8-V and 5-V devices). According to the inductor voltage- second balance, the converter exhibits a conversion ratio of M=3/(4−2D) and operates in buck mode when D<0.5 and in boost mode when D>0.5. This removes mode transitions in the converter 200 and indicates that regulation can be achieved solely by controlling the duty D. Additionally, by the charge-balance principle for the flying capacitors, the capacitor currents are given by C_{F1(φ1)}=I_{LOAD}/2D, I_{CF1(φ2)}=I_{LOAD}/(2−2D) and I_{CF2,3}I_{CF1}−(1−2D)/(2−D). Accordingly, the current of the inductor can be calculated as I_{L}=I_{LOAD}·3/(4−2D)=M·I_{LOAD}. In view of the fact that the inductor current of a conventional buck-boost converter is (M+1)·I_{LOAD}, the inductor current in the hybrid single-mode buck-boost converter 200 is consistently reduced by a factor of M/(M+1) over the entire conversion-ratio range M.

Because the drain-to-source voltages V_{DS} of S₁-S₄ and S₅-S₇ are only about V_{OUT}/3 and 2·V_{OUT}/3, respectively, the power switches can employ 1.8-V and 5-V transistors, respectively. A Type-III voltage-mode control loop regulates V_{OUT} at a switching frequency of 2 MHz. Moreover, the converter according to one embodiment of the present disclosure eliminates the complex control blocks required for mode transitions and can be driven with a simple controller.

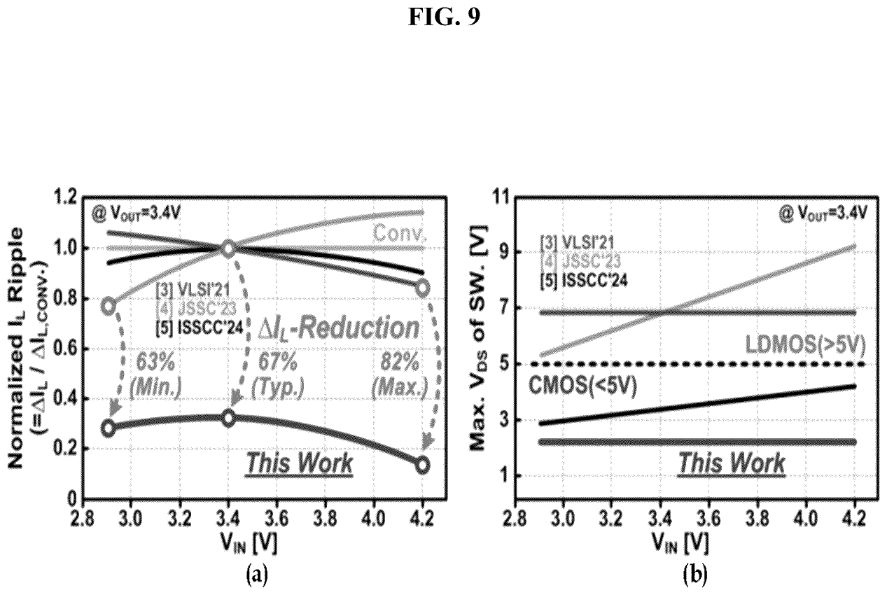

FIG. 9 is a diagram comparing the rectified inductor current ripple I_{L} and the maximum switch voltage between the prior art and a hybrid single-mode buck-boost converter according to one embodiment of the present disclosure. In reducing ΔI_{L}, the hybrid single-mode buck-boost converter 200 according to one embodiment of the present disclosure outperforms the prior art across the entire V_{IN} range. Within V_{IN}=2.9-4.2 V, the normalized ΔI_{L} ripple of the hybrid single-mode buck-boost converter 200 according to one embodiment of the present disclosure achieves a reduction of up to 82% compared with a conventional structure. Owing to the dramatic reduction in ΔI_{L}, the hybrid single-mode buck-boost converter 200 can employ a low inductance L (=0.47 μH) with small volume and small DCR, resulting in high efficiency. FIG. 9(b) compares the maximum drain-to-source voltage V_{DS} across the switches and demonstrates that the V_{DS} is sufficiently small to permit the use of low-breakdown-voltage CMOS transistors with low on-resistance R_{ON}. In view of the use of a small-DCR, small-volume inductor L together with low-R_{ON} switches, it can be seen that the hybrid single-mode buck-boost converter 200 topology according to one embodiment of the present disclosure can simultaneously maximize power efficiency and power density.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A hybrid single mode buck boost converter comprising:
an inductor having one end connected to an input voltage(V_{IN}) and another end connected to an intermediate node (Vx);
a switched-capacitor network circuit coupled to the inductor through the intermediate node (Vx) and configured to perform switching operations to maintain a voltage at the intermediate node at a specific ratio of an output voltage of the buck-boost converter; and
an output capacitor connected to the switched-capacitor network circuit through an output node.

2. The hybrid single mode buck boost converter of claim 1,
wherein the switched-capacitor network circuit comprises:
a first switch (S₁) having a first terminal connected to the inductor through the intermediate node (Vx) and a second terminal connected to a first contact node (V_{T1});
a second switch (S₂) having a first terminal connected to the first switch (S₁) through the first contact node (V_{T1});
a third switch (S₃) arranged in parallel with the first switch (S₁), having a first terminal connected to the inductor through the intermediate node (Vx) and a second terminal connected to a second contact node (V_{B1});
a fourth switch (S₄) having a first terminal connected to the first switch (S₃) through the second contact node (V_{B1}) and an output terminal connected to an output terminal of the second switch (S₂);
a first flying capacitor (C_{F1}) having a first terminal connected to the first contact node (V_{T1}) and a second terminal connected to the second contact node (V_{B1});
a fifth switch (S₅) having a first terminal connected to the intermediate node (Vx) through a third contact node (V_{T2});
a second flying capacitor (C_{F2}) having a first terminal connected to the third contact node (V_{T2});
a sixth switch (S₆) having a first terminal connected to the second flying capacitor (C_{F2}) through a fourth contact node (V_{B2}) and a second terminal connected to the fifth switch (S₅);
a seventh switch (S₇) having a first terminal connected to the second flying capacitor (C_{F2}) through the fourth contact node (V_{B2}) and a second terminal connected to ground; and
a third flying capacitor (C_{F3}) having a first terminal connected to the fifth switch (S₅) and the sixth switch (S₆) through a fifth contact node (V_{T3}), and a second terminal connected to ground.

3. The hybrid single mode buck boost converter of claim 2,
wherein the first switch(S₁) and the second switch(S₂) are cross-coupled, and the third switch(S₃) and the fourth switch(S₄) are cross-coupled.

4. The hybrid single mode buck boost converter of claim 3,
wherein the first switch(S₁) and the second switch(S₂) are each of the same transistor type selected from PMOS and NMOS, and the third switch (S₃) and the fourth switch (S₄) are each of the other transistor type.

5. The hybrid single mode buck boost converter of claim 2,
wherein the switched-capacitor network circuit is configured that, during a first phase in which the inductor is charged, the fifth switch(S₅) and the seventh switch (S₇) are turned ON to connect the second flying capacitor (C_{F2}) and the third flying capacitor (C_{F3}) in parallel so that current is delivered from ground to the intermediate node (Vx), and
the second switch (S₂) and the third switch (S₃) are turned ON to connect the first flying capacitor (C_{F1}) and the output capacitor in series.

6. The hybrid single mode buck boost converter of claim 2,
wherein the switched-capacitor network circuit is configured that, during a second phase, the first switch (S₁) and the fourth switch (S₄) are turned ON to connect the first flying capacitor (C_{F1}) and the output capacitor in series, and the sixth switch (S₆) is turned ON to connect the second flying capacitor (C_{F2}) and the third flying capacitor (C_{F3}) in series, whereby the inductor freewheels.
